(19) United States
(12) Patent Application Publication
(10) Pub. No.: US 2025/0200338 A1
(43) Pub. Date: Jun. 19, 2025

(54) SYSTEM AND METHOD FOR NEURAL NETWORK ARCHITECTURE SEARCH

(71) Applicant: Samsung Electronics Co., Ltd., Suwon-si (KR)

(72) Inventors: Minsu CHO, Long Island City, NY (US); Mostafa EL-KHAMY, San Diego, CA (US)

(21) Appl. No.: 18/433,313

(22) Filed: Feb. 5, 2024

Related U.S. Application Data
(60) Provisional application No. 63/610,050, filed on Dec. 14, 2023.

(51) Int. Cl. G06N 3/0464

(52) U.S. Cl. CPC G06N 3/0464

(57) ABSTRACT

A system and a method are disclosed for neural network architecture search. In some embodiments, the method includes: performing a neural network architecture search, wherein: the performing of the neural network architecture search includes mutating a first neural network architecture, to form a second neural network architecture, and the mutating includes adding a residual block to the first neural network architecture or removing a residual block from the first neural network architecture.

### CROSS-REFERENCE TO RELATED APPLICATION

This application claims the priority benefit under 35 U.S.C. § 119 (e) of U.S. Provisional Application No. 63/610,050, filed on Dec. 14, 2023, the disclosure of which is incorporated by reference in its entirety as if fully set forth herein.

### TECHNICAL FIELD

The disclosure generally relates to machine learning. More particularly, the subject matter disclosed herein relates to improvements to a system and method for neural network architecture search.

### SUMMARY

Neural networks may be used in various machine learning applications, including classification and generation. In some applications it may be advantageous, for example, to spot spoken keywords in segments of audio.

To solve this problem, a neural network with residual blocks may be employed. Each such residual block may or may not have a skip connection, and the neural network may be parametrized by other parameters, such as the number of residual blocks.

One issue with the above approach is that manually finding the number of residual blocks, the number and locations of the skip connections, and other parameters for which the neural network performs well may be burdensome.

To overcome these issues, systems and methods are described herein for performing a network architecture search using an aging evolution algorithm.

The above approach improves on previous methods because it may be employed to automate the process of designing the architecture of a neural network.

According to an embodiment of the present disclosure, there is provided a method, including: performing a neural network architecture search, wherein: the performing of the neural network architecture search includes mutating a first neural network architecture, to form a second neural network architecture, and the mutating includes adding a residual block to the first neural network architecture or removing a residual block from the first neural network architecture.

In some embodiments, the mutating includes modifying a value of each of one or more parameters, the parameters including: presence or absence of a skip connection on a residual block.

In some embodiments, the mutating includes modifying a value of each of one or more parameters, the parameters including: the number of subblocks of a residual block.

In some embodiments, the mutating includes modifying a value of each of one or more parameters, the parameters including: the number of output channels of a residual block.

In some embodiments, the mutating includes modifying a value of each of one or more parameters, the parameters including: the number of kernels for a convolution.

In some embodiments, the mutating includes modifying a value of each of one or more parameters, the parameters including: a stride for a convolution.

In some embodiments, the mutating includes modifying a value of each of one or more parameters, the parameters including: a dilation for a convolution.

In some embodiments, the mutating includes: identifying a plurality of modified neural network architectures each differing from the first neural network architecture; and selecting the second neural network architecture randomly from among the modified neural network architectures.

In some embodiments, the performing of the neural network architecture search further includes: adding the second neural network architecture to a population of neural network architectures, the population of neural network architectures including the first neural network architecture.

In some embodiments, the performing of the neural network architecture search further includes: deleting from the population a third neural network architecture, the third neural network architecture being older than the first neural network architecture.

In some embodiments, the performing of the neural network architecture search further includes adding the second neural network architecture to a history of neural network architectures, the history of neural network architectures including the first neural network architecture.

In some embodiments, the performing of the neural network architecture search further includes evaluating each of the neural network architectures of the history of neural network architectures using a performance metric.

In some embodiments, the performance metric includes a measure of keyword spotting accuracy.

According to an embodiment of the present disclosure, there is provided a system including: one or more processors; and a memory storing instructions which, when executed by the one or more processors, cause performance of: performing a neural network architecture search, wherein: the performing of the neural network architecture search includes mutating a first neural network architecture, to form a second neural network architecture, and the mutating includes adding a residual block to the first neural network architecture or removing a residual block from the first neural network architecture.

In some embodiments, the mutating includes modifying a value of each of one or more parameters, the parameters including: presence or absence of a skip connection on a residual block.

In some embodiments, the mutating includes modifying a value of each of one or more parameters, the parameters including: the number of subblocks of a residual block.

In some embodiments, the mutating includes modifying a value of each of one or more parameters, the parameters including: the number of output channels of a residual block.

In some embodiments, the mutating includes modifying a value of each of one or more parameters, the parameters including: the number of kernels for a convolution.

In some embodiments, the mutating includes modifying a value of each of one or more parameters, the parameters including: a stride for a convolution.

According to an embodiment of the present disclosure, there is provided a system including: means for processing; and a memory storing instructions which, when executed by the means for processing, cause performance of: performing a neural network architecture search, wherein: the performing of the neural network architecture search includes mutating a first neural network architecture, to form a second neural network architecture, and the mutating includes adding a residual block to the first neural network architecture or removing a residual block from the first neural network architecture.

### BRIEF DESCRIPTION OF THE DRAWINGS

In the following section, the aspects of the subject matter disclosed herein will be described with reference to exemplary embodiments illustrated in the figures, in which:

FIG. 1 is a system level diagram, according to an embodiment.

FIG. 2A is a block diagram of a portion of a neural network, according to an embodiment.

FIG. 2B is a block diagram of a portion of a neural network, according to an embodiment.

FIG. 3A is a flow chart of portion of a method for neural network architecture search, according to an embodiment.

FIG. 3B is a table of morphisms, according to an embodiment.

FIG. 4 is a block diagram of an electronic device in a network environment, according to an embodiment.

FIG. 5 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

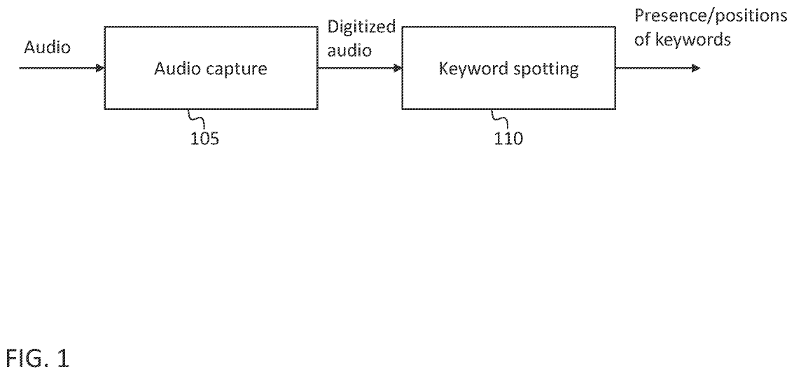

FIG. 1 illustrates a system for keyword spotting, which may be a useful function for a user interface, for example. An audio capture system 105 (which may include a microphone, an amplifier, and an analog-to-digital converter) receives and digitizes audio (e.g., a set of words spoken by a user) received during an acquisition time, and a keyword spotting neural network 110 analyzes the digital audio signal for certain keywords or phrases (e.g., “power off”). The output of the neural network may include which keywords, if any, were detected in the audio stream and, if any were detected, where in the audio stream they were detected.

As an initial processing step in the keyword spotting neural network 110, the one-dimensional vector consisting of a series of digitized samples of the audio signal may be converted to a two-dimensional array by dividing the vector into a set of shorter vectors (each corresponding to portion of the acquisition time) and calculating a two-dimensional array of mel frequency cepstral coefficients (MFCC) from the set of shorter vectors.

In some embodiments, an evolutionary neural architecture search framework may be used to generate, from e.g., a human-designed initial architecture, a neural network architecture suitable for keyword spotting (KWS). Neural architecture search may include the optimization problem of searching for an optimal solution (architecture) α*∈A from the search space A that maximizes some objective function L.

The neural network architecture search may be considered to be a multi-objective problem, including the validation set accuracy and three different resource constraints: (1) peak memory usage, (2) model size, and (3) floating-point operation (FLOP) count. Formally:

$${α}^{*} = arg {min}_{α ∈ A} L ( α ) = arg {min}_{α ∈ A} \{ 1. - ValAccuracy ( α ) , PeakMemory ( α ) , ModelSiz e ( α ) , FLOPCoun t ( α ) \}$$

In some embodiments, the multiple objectives are combined into one objective loss (or “performance metric”) L^{t}(α), which may be defined at round t as follows:

$${L}^{t} ( α ) = max \{ \begin{matrix}{λ}_{1}^{t} ( 1. - ValAccuracy ( α ) ) \\ {λ}_{2}^{t} PeakMemory ( α ) / PeakMemoryBound \\ {λ}_{3}^{t} ModelSize ( α ) / ModelSizeBound \\ {λ}_{4}^{t} FLOPCount ( α ) / FLOPBound\end{matrix}$$

where λᵢ^{t} is a randomly sampled value from the distribution 1/λᵢ^{t}˜Uniform[0; b] and b is a hyperparameter which may be set by the user to operate as a soft upper bound for the i^{th} objective, allowing the user to determine which criteria weigh more heavily more than others. In some embodiments, a different performance metric is used, such as a true positive rate at specific false positive rate. The performance metric (which may have higher values for better overall performance) may then be, e.g., 1−L^{t}(α) or 1/L^{t}(α).

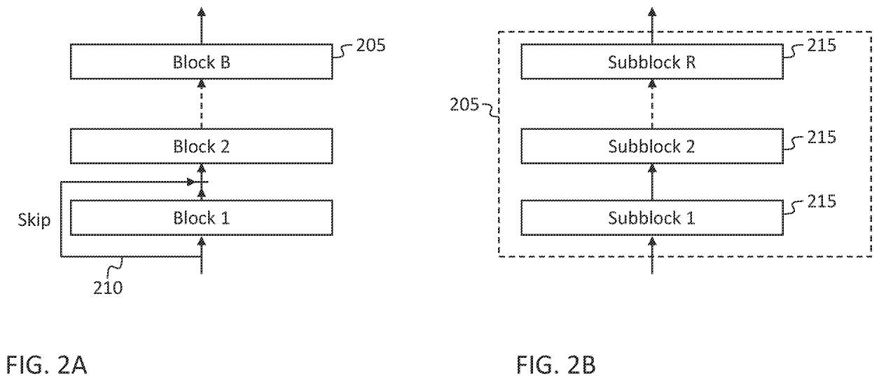

FIG. 2A shows the general structure of a portion of a neural network, in some embodiments. The portion includes a chain of B residual blocks 205. Each residual block 205 may or may not be bypassed by a skip connection (as shown, for example for Block 1 in FIG. 2A). Each residual block 205 may include, as shown in FIG. 2B, R subblocks 215, each of which may include one dimensional (1D) convolution, batch normalization, rectified linear unit (ReLU), and dropout functions. Each of the arrays that are inputs and outputs to the subblocks 215 and the residual block 205 may be a set of C two-dimensional arrays, where C is the number of channels.

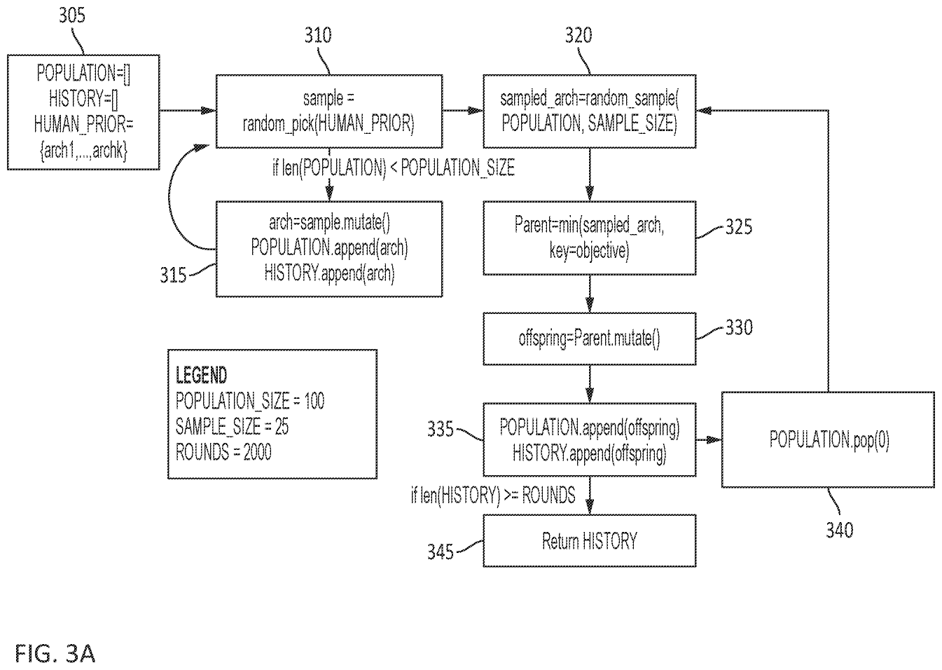

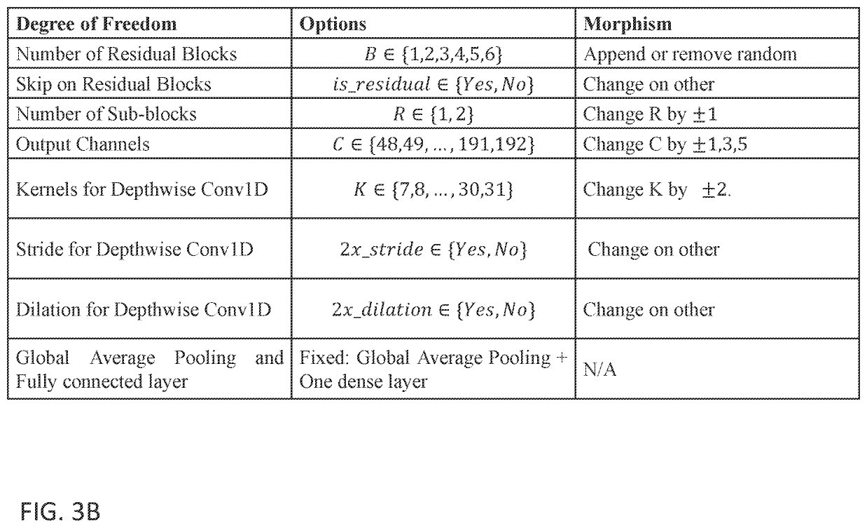

In some embodiments, an aging evolution algorithm, as illustrated in FIG. 3A, is employed to find a final neural network architecture, which may then be used for inference (e.g., to perform keyword spotting). At 305, an initial set of one or more neural network architectures is defined. At 310, a member of the initial set of one or more neural network architectures is randomly chosen, mutated, and added, at 315, to both a population of neural network architectures and a history of neural network architectures. This process of selecting a random member of the initial set of one or more neural network architectures, mutating it, and adding it to both the population of neural network architectures and the history of neural network architectures may be repeated until the size of the population is equal to the target population size (“POPULATION_SIZE” in FIG. 3A). For example, the target population size is 100, the process of selecting a random member of the initial set of one or more neural network architectures, mutating it, and adding it to both the population of neural network architectures and the history of neural network architectures may be repeated 100 times. The mutating may involve randomly changing the value of one or more parameters defining the neural network architecture, as discussed in further detail below.

The initial set of one or more neural network architectures may be or include one or more human-designed neural network architectures. In such an embodiment, the aging evolution algorithm may have the effect of improving a human-designed neural network architecture, if improvements are possible (e.g., if human-designed the neural network architecture is not already optimal). In some other embodiments, one or more randomly-generated sets of parameters may be used to define some or all of the initial set of one or more neural network architectures. The use of one or more human-designed neural network architectures as elements of the initial set of one or more neural network architectures may result in more rapid convergence (than the use of randomly-generated sets of parameters) to a neural network architecture that shows optimal performance or that shows performance meeting a performance goal.

The method may then proceed to step 320. In step 320, a sampled subset, including a subset of the neural network architectures of the population, may be randomly selected from the population of neural network architectures. The size of this sampled subset (which may be referred to as the “sample size”, and which is labeled “SAMPLE_SIZE” in FIG. 3A) may be, e.g., between 5% and 70% of the population, e.g., it may be 25% of the population (e.g., 25 neural network architectures in an embodiment in which the population size is 100 neural network architectures).

From among the neural network architectures of the sampled subset, a parent neural network architecture may then be selected, at 325. The parent neural network architecture may be the neural network architecture, of the neural network architectures in the sampled subset, that has the best performance, according to the performance metric. The parent neural network architecture may then be mutated, at 330, to form an offspring neural network architecture, which may be added, at 335, to the population of neural network architectures and to the history of neural network architectures.

At 340, the oldest member of the population of neural network architectures may be deleted from the population of neural network architectures, and the process may be repeated, with execution returning to step 320. As used herein, a first member of the population is “older” than a second member of the population if the first member was added to the population before the second member. The loop including steps 320-340 may be repeated a fixed number of times, which may be referred to as the number of rounds, and which may be between 100 rounds and 100,000 rounds, e.g., 2,000 rounds, as shown in the legend of FIG. 3A. Each round may result in increase of one in the size of the history of neural network architectures (i.e., the history may continue to grow), while the size of the population neural network architectures may remain within one of the target population size. The values shown in the legend of FIG. 3A are examples only; in some embodiments different values are employed.

Once the set number of rounds has been completed, the history may be returned, at 345. Each member of the history of neural network architectures (e.g., each of the 2100 members of the history of neural network architectures in an embodiment in which the target population size is equal to 100 and the number of rounds is 2000) may be evaluated using the performance metric, and the member of the history of neural network architectures which has the highest value of the performance metric may be selected as the final neural network architecture (and may be used for inference operations).

Examples of performance metrics are discussed above. Some performance metrics may be relatively costly to evaluate because they may involve (i) training a neural network with the architecture being evaluated, and (ii) measuring the accuracy (e.g., the keyword spotting accuracy) of the trained neural network (e.g., using a validation data set). In such a procedure, the training (and therefore, the evaluation of the performance metric) may be costly. As such, in some embodiments, some or all of the training may be done using only a subset of the available training data, or a training-free metric may be used for the entire aging evolution algorithm, or a training-free metric may be used for the selection of a parent neural network architecture from the population of neural network architectures, at 325 in FIG. 3A. Examples of training-free metrics may include (i) calculating the number of linear regions (ii) calculating neural tangent kernels, (iii) measuring the trace norm, or (iv) calculating the size and FLOP count.

The number of linear regions may be employed as follows. For neural networks with ReLU activation functions, the ReLU function defines a linear boundary and divides its input space into two regions. Since the neural network is the composition of ReLU, it forms a high-dimensional piecewise linear function partitioning into the input space into distinct linear regions. Therefore, the expressivity of neural networks may be estimated with the number of linear regions. For example, if R_{α,θ} is a number of linear regions of neural network a parameterized with θ, then since the optimal θ for the given neural network is not known, it may be approximated by the number of regions by taking the expectations of randomly initialized parameters (using, e.g., Kaiming Norm Initialization):

Estimated Number of Linear Regions of α=E_{θ}[R_{α,θ}]

A neural tangent kernel may be employed as follows. The neural tangent kernel (NTK) provides a framework to understand the training dynamics of deep neural networks from the initialization. Informally, NTK is the Gram matrix from the dot product of two gradient vectors based on two different inputs. NTK-based metrics may be able to provide an approximation of network performance that can be measured from randomly initialized parameters: Frobenius Norm and condition number.

If Θ_{θ}_{₀} is the NTK from the random initialization θ₀, then NTK-based metrics can be defined as follows (with lower values being indications of better performance):
1. Frobenius Norm: ∥Θ_{θ}_{₀}∥_{F}
2. Condition Number of Θ_{θ}_{₀}:=λ₀/λₘ, where λᵢ are eigenvalues and λ₀≥λ₁≥ . . . ≥λₘ

The model size and FLOP count may be used as follows. Given a randomly selected model, the performance of the model may be estimated using a convex combination of model size and FLOP count. This assumption comes from the empirical observation that the neural network performance is correlated to its model complexity, as illustrated in the following equation:

$$β \cdot ModelSize ( α ) + ( 1 - β ) F L O P C o u n t ( α ) , \qquad β ∈ [ 0 , 1 ]$$

Each mutation may be performed based on the morphisms of Table 1 (the table of FIG. 3B). Each morphism specifies a parameter that may be modified as a result of a mutation, and the value that the parameter may take for an offspring neural network architecture, based on the value that the parameter has in the parent neural network architecture. For example, in the embodiment illustrated in FIG. 3B, the number of residual blocks may range from 1 to 6, and the number of residual blocks of the offspring neural network architecture may differ by one from the number of residual blocks of the parent neural network architecture (e.g., the mutating may include adding a residual block to the parent neural network architecture or removing a residual block from the parent neural network architecture). The right-most (third) column of Table 1 (FIG. 3B) (the column labeled “Morphism”) specifies the extent to which the value of each parameter may differ between a parent neural network architecture and an offspring neural network architecture. The possibilities for changes shown in the third column (the “Morphism” column) are examples only, and in some embodiments, different possibilities for changes are employed. For example, the presence or absence of a skip connection is a parameter that may change between its two possible values (as indicated by “Change on other” in the third column of Table 1). The middle (second) column of Table 1 (FIG. 3B) (the column labeled “Options”) specifies, for each row, the range of values that the parameter (or “Degree of Freedom”) of the row may take. These ranges of values are examples only, and in some embodiments, different ranges of values are employed. The changes allowed in each mutation may affect the model size and the performance of the mutated architecture. For example, the maximum number of blocks may affect the upper bound of model size and FLOP count, and the maximum number of kernels may affect the upper bound of model size and, to a greater extent, the FLOP count.

As illustrated in FIG. 3B, other morphisms may include adding or removing a skip connection from any of the residual blocks 205, changing the number of subblocks 215 in any of the residual blocks 205, changing the number of output channels of each of the residual blocks 205, changing the number of kernels for a depth-wise one-dimensional convolution, changing the stride for a depth-wise one-dimensional convolution, or changing the dilation for a depth-wise one-dimensional convolution (where the use of a depth-wise separable convolution layer is a method to reduce the computational complexity compared to the use of a vanilla convolution layer). The number of residual blocks and subblocks may determine the depth of the neural networks; a deeper network may allow higher-abstract features to help accurate classification, at a cost in terms of model size and FLOP count. The kernel size of each 1D pointwise convolution may control the receptive field of input at a cost in model size and FLOP count. One-dimensional (1D) convolutions may be employed when processing 2D input feature maps (IFMs) because of the characteristics of audio input. The 1D audio input may be converted into 2D input (in preprocessing) as follows. First, the 1D audio signal is divided into multiple segments by framing and windowing. Second, a short time Fourier transform (STFT) is performed for each frame. Third, the power of the STFT output is computed. Fourth, the log-Mel spectrogram is calculated. Fifth, a discrete cosine transform is performed to obtain the Mel-frequency cepstrum (MFCC). The MFCC may then be employed as the 2D input (e.g., the first IFM) where one axis corresponds to time and the other axis is the frequency. In this case a 1D convolution may be applied along the frequency axis and may produce good performance. Compared to a 2D convolution with a square filter, the computational complexity of the 1D convolution (at O(n)) may be significantly lower than the (O(n\hat{ }2)) computational complexity of a 2D convolution.

The presence of skip-connections, increased stride, and increased dilation may reduce the computational complexity without reducing the model size, or with only slight changes in the model size. Skip connections may help to avoid the gradient-vanishing problem, stabilizing the training process; however, when a skip connection is used the memory space consumed before the addition operation (which follows the skip connection) is double the memory space used when the skip connection is absent. The use of a double stride (2× stride) may make it possible to calculate the convolution operation with roughly half the FLOP count. Using a dilated convolution (2× dilation) may increase the receptive field without increasing the model size.

In some embodiments, the process of mutating a parent neural network architecture to form an offspring neural network architecture may involve (i) identifying a complete set of modified neural network architectures each of which can be formed from the parent neural network architecture by applying a combination of morphisms from Table 1 to the parent neural network architecture, and (ii) randomly selecting one of the modified neural network architectures (e.g., using a uniformly distributed pseudorandom number) as the offspring neural network architecture.

Some embodiments may achieve good performance in either of two regimes, including (i) large models, with a model size less than 85,000 (85 k) (the size being the number of parameters or weights) and (ii) small models, with a model size of 35 k. In the large model size regime, some embodiments achieve 97.67% test accuracy, in spite of a savings of approximately 40% FLOP over related art neural networks. In the small model size regime some embodiments achieve higher test accuracy than related art neural networks with 6 times lower FLOP count.

In some embodiments, a network with an architecture generated using an embodiment disclosed herein may be implemented in a User Equipment, e.g., in a mobile telephone. Such a neural network may be employed in such a device for recognizing voice commands from a user, for example.

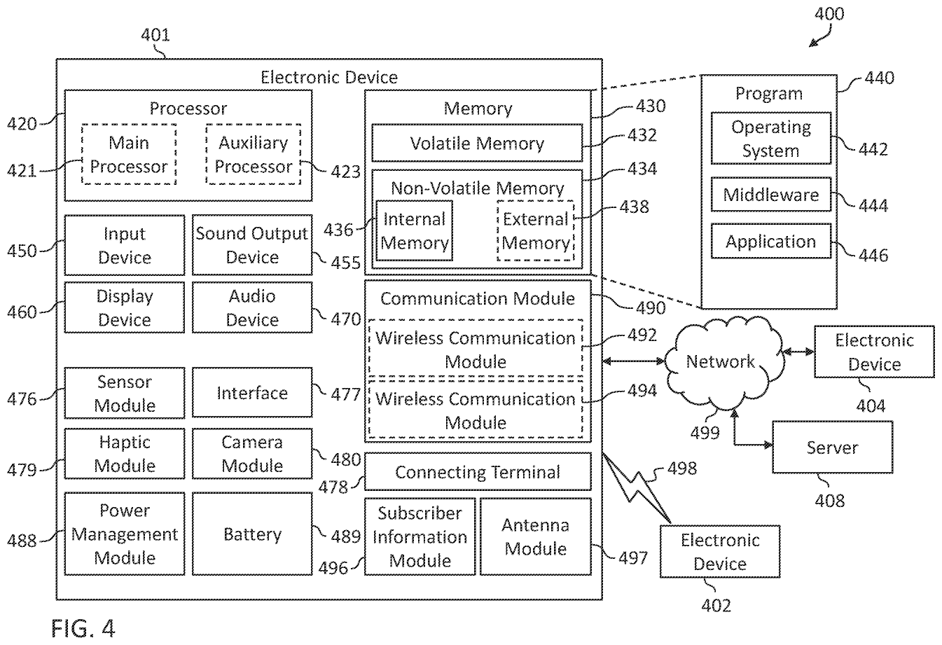

FIG. 4 is a block diagram of an electronic device in a network environment 400, according to an embodiment. The electronic device 401 may include a neural network having an architecture generated by an embodiment disclosed herein.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

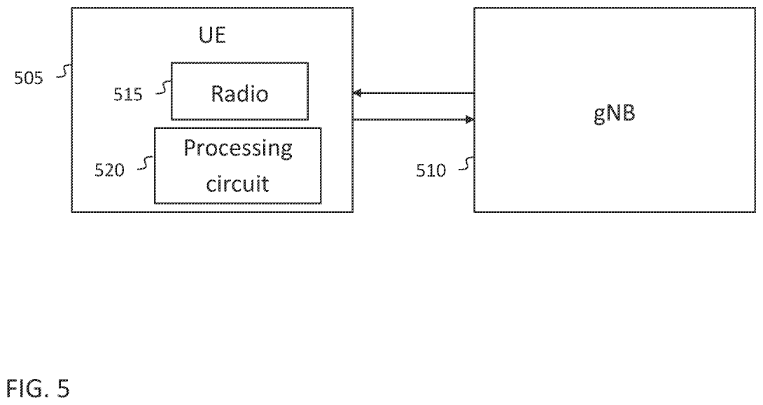

FIG. 5 shows a system including a UE 505 and a gNB 510, in communication with each other. The UE may include a radio 515 and a processing circuit (or a means for processing) 520, which may perform various methods disclosed herein, e.g., the method illustrated in FIG. 3A. For example, the processing circuit 520 may receive, via the radio 515, transmissions from the network node (gNB) 510, and the processing circuit 520 may transmit, via the radio 515, signals to the gNB 510.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
performing a neural network architecture search, wherein:
the performing of the neural network architecture search comprises mutating a first neural network architecture, to form a second neural network architecture, and
the mutating comprises adding a residual block to the first neural network architecture or removing a residual block from the first neural network architecture.

2. The method of claim 1, wherein the mutating comprises modifying a value of each of one or more parameters, the parameters comprising:
presence or absence of a skip connection on a residual block.

3. The method of claim 1, wherein the mutating comprises modifying a value of each of one or more parameters, the parameters comprising:
the number of subblocks of a residual block.

4. The method of claim 1, wherein the mutating comprises modifying a value of each of one or more parameters, the parameters comprising:
the number of output channels of a residual block.

5. The method of claim 1, wherein the mutating comprises modifying a value of each of one or more parameters, the parameters comprising:
the number of kernels for a convolution.

6. The method of claim 1, wherein the mutating comprises modifying a value of each of one or more parameters, the parameters comprising:
a stride for a convolution.

7. The method of claim 1, wherein the mutating comprises modifying a value of each of one or more parameters, the parameters comprising:
a dilation for a convolution.

8. The method of claim 1, wherein the mutating comprises:
identifying a plurality of modified neural network architectures each differing from the first neural network architecture; and
selecting the second neural network architecture randomly from among the modified neural network architectures.

9. The method of claim 1, wherein the performing of the neural network architecture search further comprises:
adding the second neural network architecture to a population of neural network architectures,
the population of neural network architectures comprising the first neural network architecture.

10. The method of claim 9, wherein the performing of the neural network architecture search further comprises:
deleting from the population a third neural network architecture, the third neural network architecture being older than the first neural network architecture.

11. The method of claim 9, wherein the performing of the neural network architecture search further comprises adding the second neural network architecture to a history of neural network architectures,
the history of neural network architectures comprising the first neural network architecture.

12. The method of claim 9, wherein the performing of the neural network architecture search further comprises evaluating each of the neural network architectures of the history of neural network architectures using a performance metric.

13. The method of claim 12, wherein the performance metric comprises a measure of keyword spotting accuracy.

14. A system comprising:
one or more processors; and
a memory storing instructions which, when executed by the one or more processors, cause performance of:
performing a neural network architecture search, wherein:
the performing of the neural network architecture search comprises mutating a first neural network architecture, to form a second neural network architecture, and
the mutating comprises adding a residual block to the first neural network architecture or removing a residual block from the first neural network architecture.

15. The system of claim 14, wherein the mutating comprises modifying a value of each of one or more parameters, the parameters comprising:
presence or absence of a skip connection on a residual block.

16. The system of claim 14, wherein the mutating comprises modifying a value of each of one or more parameters, the parameters comprising:
the number of subblocks of a residual block.

17. The system of claim 14, wherein the mutating comprises modifying a value of each of one or more parameters, the parameters comprising:
the number of output channels of a residual block.

18. The system of claim 14, wherein the mutating comprises modifying a value of each of one or more parameters, the parameters comprising:
the number of kernels for a convolution.

19. The system of claim 14, wherein the mutating comprises modifying a value of each of one or more parameters, the parameters comprising:
a stride for a convolution.

20. A system comprising:
means for processing; and
a memory storing instructions which, when executed by the means for processing, cause performance of:
performing a neural network architecture search, wherein:
the performing of the neural network architecture search comprises mutating a first neural network architecture, to form a second neural network architecture, and
the mutating comprises adding a residual block to the first neural network architecture or removing a residual block from the first neural network architecture.
